(19) United States
(12) Patent Application Publication
(10) Pub. No.: US 2021/0045468 A1
(43) Pub. Date: Feb. 18, 2021

(54) Heated Coverall Garment Assembly

(71) Applicant: Gina Edwards, Boaz, AL (US)

(72) Inventor: Gina Edwards, Boaz, AL (US)

(21) Appl. No.: 16/539,296

(22) Filed: Aug. 13, 2019

(51) Int. Cl. A41D 13/005; A41D 3/00; A41D 1/00; H05B 3/34; H05B 1/02

(52) U.S. Cl. CPC A41D 13/0051; A41D 3/00; A41D 1/005; H05B 2203/003; H05B 1/0272; H05B 2203/036; H05B 3/342

(57) ABSTRACT

A heated coverall garment assembly for warming a user includes a shell that comprises an inner layer and an outer layer. The outer layer is insulative. The shell is substantially body shaped and is configured to be positioned over a body of a user so that a face, hands, and feet of the user are exposed. A power module is coupled to the shell. A heating element is coupled to the shell and is positioned between the inner layer and the outer layer. The heating element is operationally coupled to the power module so that the power module is positioned to power the heating element to warm the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relate to garment assemblies and more particularly pertain to a new garment assembly for warming a user.

### BRIEF SUMMARY OF THE INVENTION

An embodiment of the disclosure meets the needs presented above by generally comprising a shell that comprises an inner layer and an outer layer. The outer layer is insulative. The shell is substantially body shaped and is configured to be positioned over a body of a user so that a face, hands, and feet of the user are exposed. A power module is coupled to the shell. A heating element is coupled to the shell and is positioned between the inner layer and the outer layer. The heating element is operationally coupled to the power module so that the power module is positioned to power the heating element to warm the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a heated coverall garment assembly according to an embodiment of the disclosure.

FIG. 2 is a rear view of an embodiment of the disclosure.

FIG. 3 is a side view of an embodiment of the disclosure.

FIG. 4 is a cross-sectional view of an embodiment of the disclosure.

FIG. 5 is an in-use view of an embodiment of the disclosure.

FIG. 6 is a detail view of an embodiment of the disclosure.

### DETAILED DESCRIPTION OF THE INVENTION

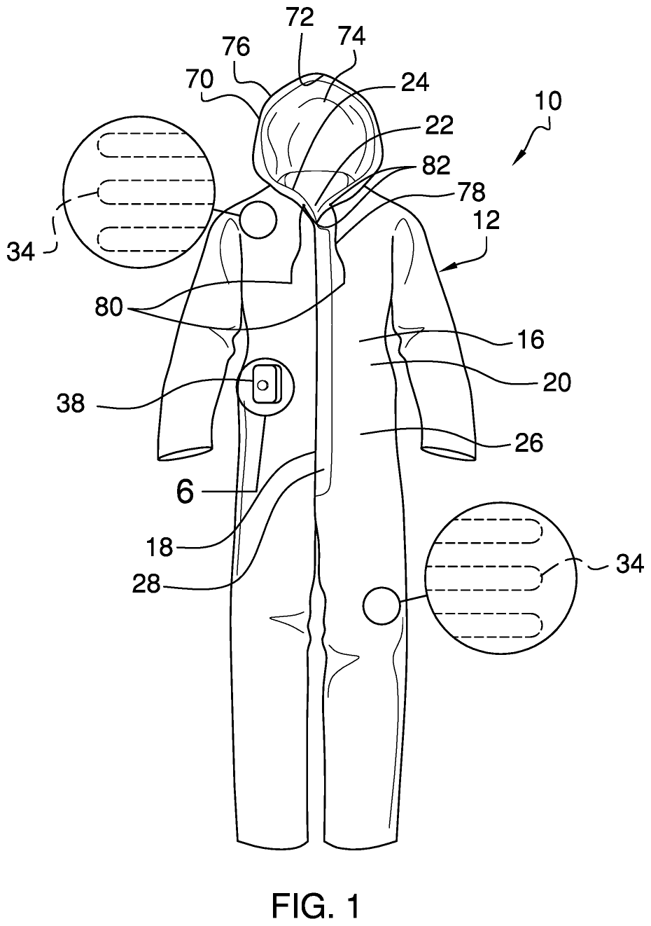

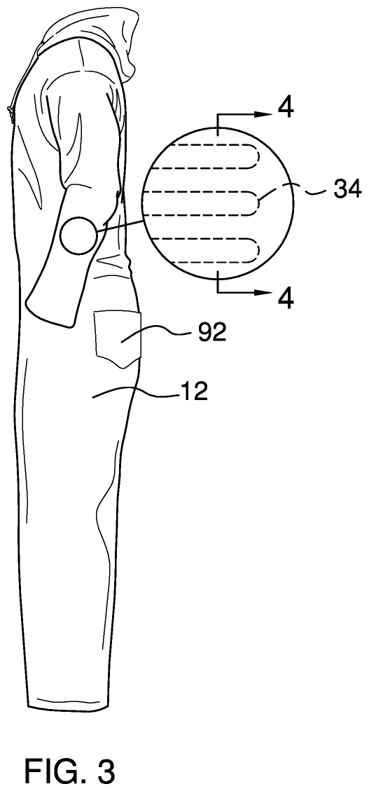

With reference now to the drawings, and in particular to FIGS. 1 through 6 thereof, a new garment assembly embodying the principles and concepts of an embodiment of the disclosure and generally designated by the reference numeral 10 will be described.

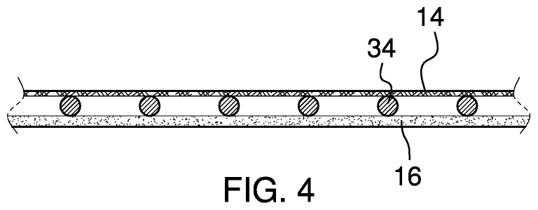

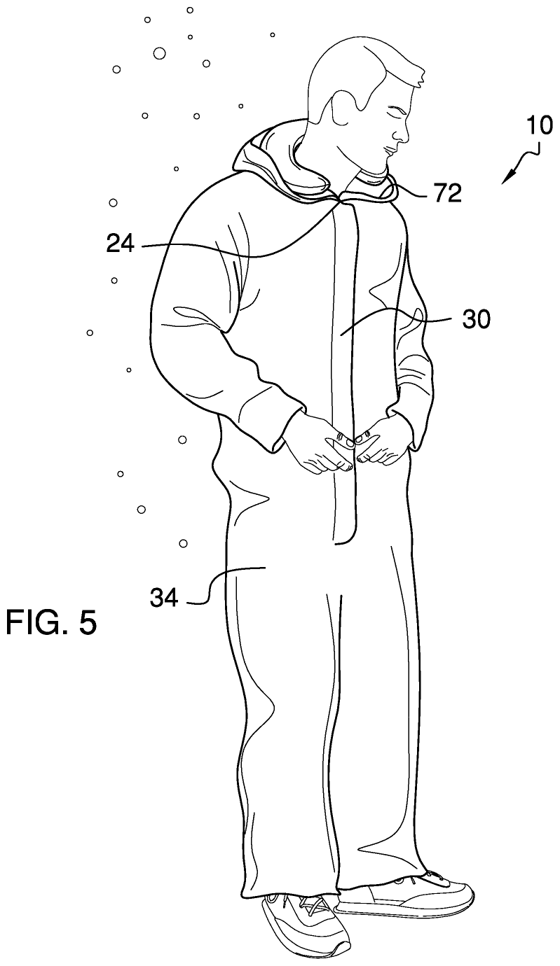

As best illustrated in FIGS. 1 through 6, the heated coverall garment assembly 10 generally comprises a shell 12 that comprises an inner layer 14 and an outer layer 16, as shown in FIG. 4. The outer layer 16 is insulative. The shell 12 is substantially body shaped and is configured to be positioned over a body of a user, as shown in FIG. 5, so that a face, hands, and feet of the user are exposed.

A slit 18 is positioned vertically in a front 20 of the shell 12 and extends from a lower perimeter 22 of a neckline 24 to a waist 26 of the shell 12. A closure 28 is coupled to the shell 12 proximate to the slit 18, as shown in FIG. 1. The closure 28 is configured to selectively open the slit 18, positioning the user to don the shell 12. The closure 28 may comprise a zipper 30, or other fastening means, such as, but not limited to, hook and loop fasteners, buttons, snaps, and the like.

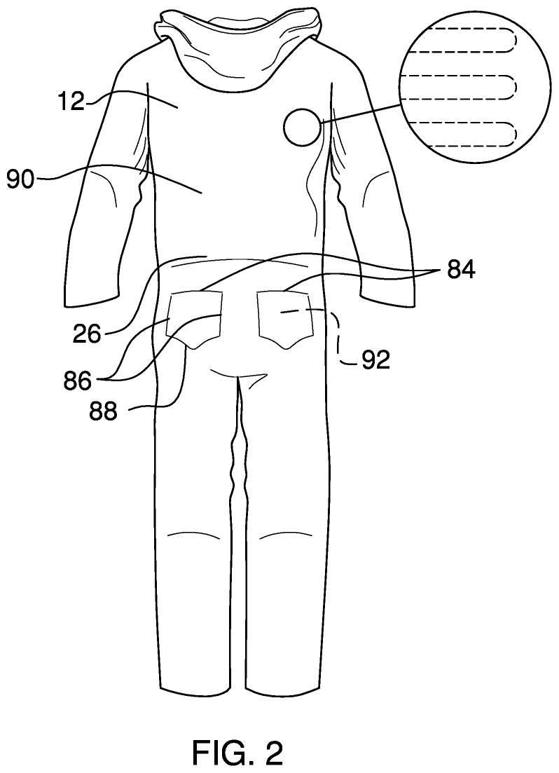

A power module 32 and a heating element 34 are coupled to the shell 12. The power module 32 comprises a battery 36 that is rechargeable. The heating element 34, which is positioned between the inner layer 14 and the outer layer 16, is operationally coupled to the power module 32 so that the power module 32 is positioned to power the heating element 34 to warm the user. The assembly 10 allows the user to participate in outdoor activities in cold weather. The heating element 34 is positioned in a zigzag configuration, as shown in FIG. 2, so that the heating element 34 is positioned to evenly heat the inner layer 14.

A control module 38 is coupled to the shell 12, as shown in FIG. 1. The control module 38 is operationally coupled to the power module 32 and the heating element 34 so that the control module 38 is positioned to control a power level to the heating element 34 so that the heating element 34 warms to a temperature desired by the user. The control module 38 is coupled to the outer layer 16 proximate to the waist 26 and on the front 20 of the shell 12, as shown in FIG. 1.

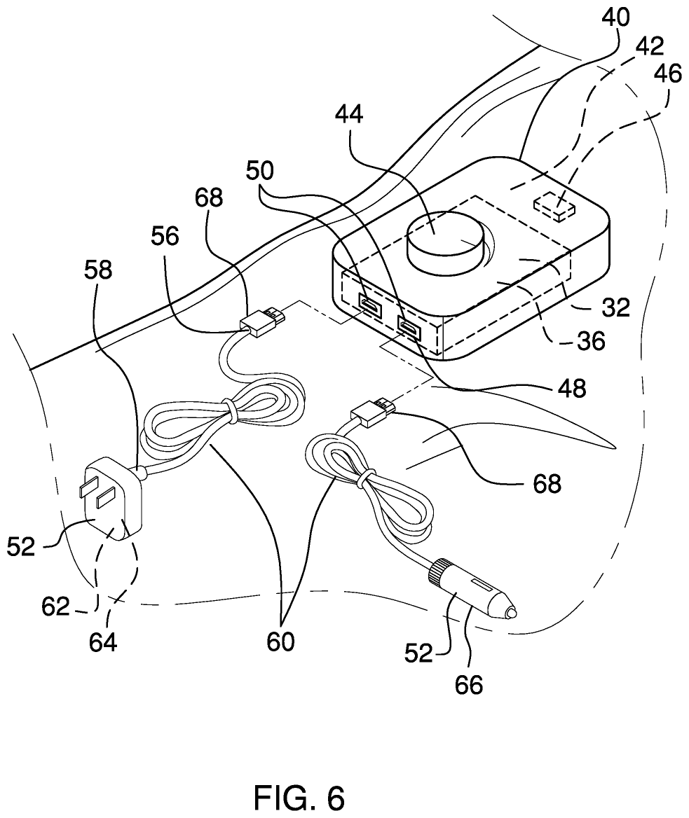

The control module 38 comprises a housing 40 that defines an interior space 42, as shown in FIG. 6. The power module 32 is coupled to the housing 40 and is positioned in the interior space 42. The housing 40 is substantially rectangularly box shaped. A thermostat 44 is coupled to the housing 40. The thermostat 44 is operationally coupled to the power module 32 and the heating element 34 so that the thermostat 44 is positioned to control the power level to the heating element 34 so that the heating unit warms to the temperature desired by the user. The thermostat 44 may dial type, as shown in FIG. 6, or other type, such as, but not limited to, slide switch type, electronic type, and the like.

A fuse 46 is coupled to the housing 40 and is positioned in the interior space 42. The fuse 46 is operationally coupled to the power module 32 and the heating element 34 so that the fuse 46 is configured to provide overcurrent protection.

A first connector 48 is coupled to the housing 40. The first connector 48 is operationally coupled to the battery 36. The first connector 48 may comprise a port 50. The first connector 48 may comprise a pair of ports 50.

A plug 52 is coupled to a first end 58 of a power cable 60. The plug 52 may comprise a transformer 62 and a rectifier 64, as shown in FIG. 6. The plug 52 is configured to be coupled to a source of alternating current so that the transformer 62 and the rectifier 64 are positioned to convert the alternating current to direct current and to supply the direct current through the power cable 60.

The plug 52 also may comprise a cigarette lighter plug 66. The cigarette lighter plug 66 is configured to be inserted into a cigarette lighter receptacle to supply direct current through the power cable 60.

A second connector 68 is coupled to a second end 56 of the power cable 60. The second connector 68 is complementary to the first connector 48 so that the second connector 68 is positioned to be selectively coupled to the first connector 48 to supply the direct current to the battery 36 to charge the battery 36.

A sleeve 70 is coupled to the shell 12 and extends substantially around a circumference 72 of a hood opening 74 to define a channel 76. A drawstring 78 is positioned through the channel 76 so that each opposing end 80 of the drawstring 78 extends from the channel 76 through a respective one of a pair of openings 82 that is positioned in the outer layer 16 proximate to the neckline 24 of the shell 12. The drawstring 78 is positioned to be tightened to selectively reduce the circumference 72 of the hood opening 74.

Each of a pair of panels 84 has opposing sides 86 and a bottom 88 that are coupled to a rear 90 of the shell 12, proximate to and below the waist 26, to define a pocket 92, as shown in FIG. 2.

In use, the battery 36 is charged using the power cable 60. The user dons the shell 12, which, with the outer layer 16 being insulative, provides a level of protection from cold. Should the user desire to be warmed, the thermostat 44 can be adjusted a desired level so that the heating element 34 warms the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A heated coverall garment assembly comprising:
a shell comprising an inner layer and an outer layer, the outer layer being insulative, the shell being substantially body shaped wherein the shell is configured for positioning over a body of a user such that a face, hands, and feet of the user are exposed;
a power module coupled to the shell; and
a heating element coupled to the shell and positioned between the inner layer and the outer layer, the heating element being operationally coupled to the power module such that the power module is positioned for powering the heating element for warming the user.

2. The assembly of claim 1, further comprising:
a slit positioned vertically in a front of the shell and extending from a lower perimeter of a neckline to a waist of the shell; and
a closure coupled to the shell proximate to the slit wherein the closure is configured for selectively opening the slit positioning the user for donning the shell.

3. The assembly of claim 2, further including the closure comprising a zipper.

4. The assembly of claim 1, further including the heating element being positioned in zigzag configuration such that the heating element is positioned for evenly heating the inner layer.

5. The assembly of claim 1, further including a control module coupled to the shell, the control module being operationally coupled to the power module and the heating element such that the control module is positioned for controlling a power level to the heating element such that the heating element warms to a temperature desired by the user.

6. The assembly of claim 5, further including the control module being coupled to the outer layer proximate to the waist and on the front of the shell.

7. The assembly of claim 5, further including the control module comprising:
a housing defining an interior space, the power module being coupled to the housing and positioned in the interior space; and
a thermostat coupled to the housing, the thermostat being operationally coupled to the power module and the heating element such that the thermostat is positioned for controlling the power level to the heating element such that the heating element warms to the temperature desired by the user.

8. The assembly of claim 7, further including the housing being substantially rectangularly box shaped.

9. The assembly of claim 7, further including the thermostat being dial type.

10. The assembly of claim 7, further including a fuse coupled to the housing and positioned in the interior space, the fuse being operationally coupled to the power module and the heating element wherein the fuse is configured for providing overcurrent protection.

11. The assembly of claim 7, further comprising:
the power module comprising a battery, the battery being rechargeable;
a first connector coupled to the housing, the first connector being operationally coupled to the battery;
a power cable;
a plug coupled to a first end of the power cable, the plug comprising a transformer and a rectifier wherein the plug is configured for coupling to a source of alternating current such that the transformer and the rectifier are positioned for converting the alternating current to direct current for supplying the direct current through the power cable; and
a second connector coupled to a second end of the power cable, the second connector being complementary to the first connector such that the second connector is positioned for selectively coupling to the first connector for supplying the direct current to the battery for charging the battery.

12. The assembly of claim 11, further including the first connector comprising a port.

13. The assembly of claim 11, further including the first connector comprising a pair of ports.

14. The assembly of claim 11, further including the plug comprising a cigarette lighter plug wherein the cigarette lighter plug is configured for inserting into a cigarette lighter receptacle for supplying direct current through the power cable.

15. The assembly of claim 1, further comprising:
a sleeve coupled to the shell and extending substantially around a circumference of a hood opening defining a channel; and
a drawstring positioned through the channel such that each opposing end of the drawstring extends from the channel through a respective one of a pair of openings positioned in the outer layer proximate to the neckline of the shell wherein the drawstring is positioned for tightening for selectively reducing the circumference of the hood opening.

16. The assembly of claim 1, further including a pair of panels, each panel having opposing sides and a bottom coupled to a rear of the shell proximate to and below the waist defining a pocket.

17. A heated coverall garment assembly comprising:
a shell comprising an inner layer and an outer layer, the outer layer being insulative, the shell being substantially body shaped wherein the shell is configured for positioning over a body of a user such that a face, hands, and feet of the user are exposed;
a slit positioned vertically in a front of the shell and extending from a lower perimeter of a neckline to a waist of the shell;
a closure coupled to the shell proximate to the slit wherein the closure is configured for selectively opening the slit positioning the user for donning the shell, the closure comprising a zipper;
a power module coupled to the shell, the power module comprising a battery, the battery being rechargeable;
a heating element coupled to the shell and positioned between the inner layer and the outer layer, the heating element being operationally coupled to the power module such that the power module is positioned for powering the heating element for warming the user, the heating element being positioned in zigzag configuration such that the heating element is positioned for evenly heating the inner layer;
a control module coupled to the shell, the control module being operationally coupled to the power module and the heating element such that the control module is positioned for controlling a power level to the heating element such that the heating element warms to a temperature desired by the user, the control module being coupled to the outer layer proximate to the waist and on the front of the shell, the control module comprising:
a housing defining an interior space, the power module being coupled to the housing and positioned in the interior space, the housing being substantially rectangularly box shaped,
a thermostat coupled to the housing, the thermostat being operationally coupled to the power module and the heating element such that the thermostat is positioned for controlling the power level to the heating element such that the heating element warms to the temperature desired by the user, the thermostat being dial type, and
a fuse coupled to the housing and positioned in the interior space, the fuse being operationally coupled to the power module and the heating element wherein the fuse is configured for providing overcurrent protection;
a first connector coupled to the housing, the first connector being operationally coupled to the battery, the first connector comprising a port, the first connector comprising a pair of ports;
a power cable;
a plug coupled to a first end of the power cable, the plug comprising a transformer and a rectifier wherein the plug is configured for coupling to a source of alternating current such that the transformer and the rectifier are positioned for converting the alternating current to direct current for supplying the direct current through the power cable, the plug comprising a cigarette lighter plug wherein the cigarette lighter plug is configured for inserting into a cigarette lighter receptacle for supplying direct current through the power cable;
a second connector coupled to a second end of the power cable, the second connector being complementary to the first connector such that the second connector is positioned for selectively coupling to the first connector for supplying the direct current to the battery for charging the battery;
a sleeve coupled to the shell and extending substantially around a circumference of a hood opening defining a channel;
a drawstring positioned through the channel such that each opposing end of the drawstring extends from the channel through a respective one of a pair of openings positioned in the outer layer proximate to the neckline of the shell wherein the drawstring is positioned for tightening for selectively reducing the circumference of the hood opening; and
a pair of panels, each panel having opposing sides and a bottom coupled to a rear of the shell proximate to and below the waist defining a pocket.
